(19) United States
(12) Patent Application Publication
(10) Pub. No.: US 2016/0023501 A1
(43) Pub. Date: Jan. 28, 2016

(54) Adjustable eraser assembly for a wooden pencil

(71) Applicant: Cathy M. Hernandez, Round Rock, TX (US)

(72) Inventor: Cathy M. Hernandez, Round Rock, TX (US)

(21) Appl. No.: 14/289,621

(22) Filed: Jul. 28, 2014

(51) Int. Cl. B43K 29/02; B43K 21/00; B43K 19/02

(52) U.S. Cl. CPC B43K 29/02; B43K 19/02; B43K 21/006

(57) ABSTRACT

The assembly consists of guide rails, a ferrule, a circular raceway, an eraser platform with threaded extrusions, and a threaded barrel with an outer stop. The guide rails, ferrule, and circular raceway are rigidly attached to the wooden pencil. The threaded barrel is attached to the circular raceway, allowing for free rotation of the threaded barrel while restricting its longitudinal movement. The eraser platform is located inside the threaded barrel with its threaded extrusions positioned between the guide rails and interlocking with the barrel's threads. The eraser platform is limited in its overall longitudinal travel by the outer stop of the barrel. The eraser is firmly attached to the eraser platform. This assembly allows for longitudinal movement of the eraser platform, providing adjustability to the exposed length of the eraser.

### BACKGROUND

Graphite pencils are writing instruments that are frequently used in various occupations and hobbies. Pencils have a center made from graphite and clay powders. The graphite is commonly encased in a wood or wood-like material allowing for a hygienic and easy grip of the material. Modern day pencils do not contain lead, but the graphite material continues to be referred to as “lead”, and the pencil as a “lead pencil.”

As the sharp tip of graphite at the pencils end wears or breaks off, one need only sharpen the wood casing to be able to expose a sharp, new point that continues to be used repeatedly. At the opposite end of the pencil case is a metal ferrule housing an eraser that is most typically made of synthetic rubber. The rubber eraser is relatively. small in size when compared to the amount of “lead” that is available on a pencil. As a correction needs to be made by a user of a pencil, the user simply must rub the rubber eraser over the dark lines created by the pencil and the markings seemingly disappear. A problem arises when the ferrule ceases to bear any more rubber eraser material.

It is at the point that a pencil is often deemed as being worthless. People in work places or classrooms often abandon hundreds of pencils, which still have ample “lead” use, as unusable, simply because it no longer offers an available eraser.

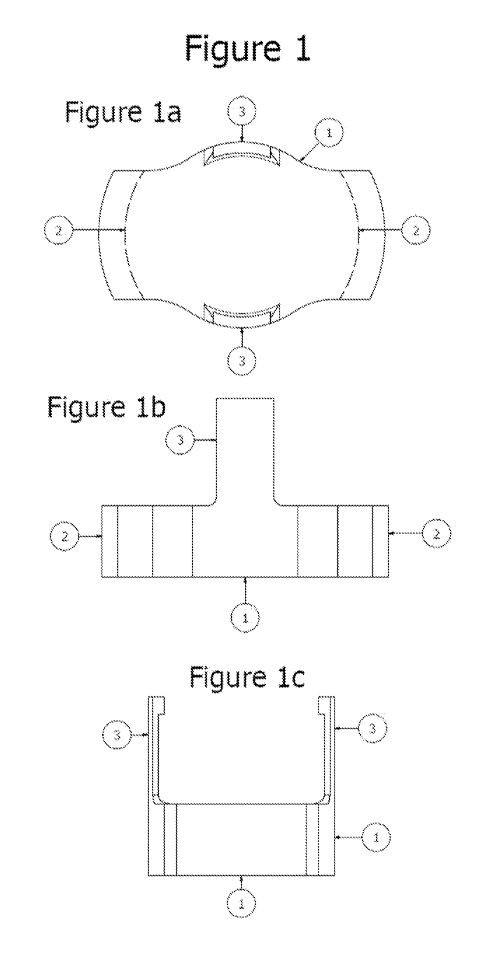

FIG. 1: The eraser platform is shown from several different positions with features shown: (1) an eraser support, (2) threaded extrusions, and (3) notched/hooked extrusion. The eraser platform supports and grips the eraser to allow for a rigid connection between the two using (1) and (3). The eraser platform's threaded extrusions (2) interlocks with the threaded barrel to allow for longitudinal travel of the eraser platform and eraser.

FIG. 1a: Top view of the eraser platform showing the: (1) eraser support, (2) threaded extrusions, and the (3) notched/hooked extrusions.

FIG. 1b: Profile view of the eraser platform showing the: (1) eraser support, (2) threaded extrusions, and the (3) notched/hooked extrusions.

FIG. 1c: End view of the eraser platform showing the: (1) eraser support, (2) threaded extrusions, and the (3) notched/hooked extrusions.

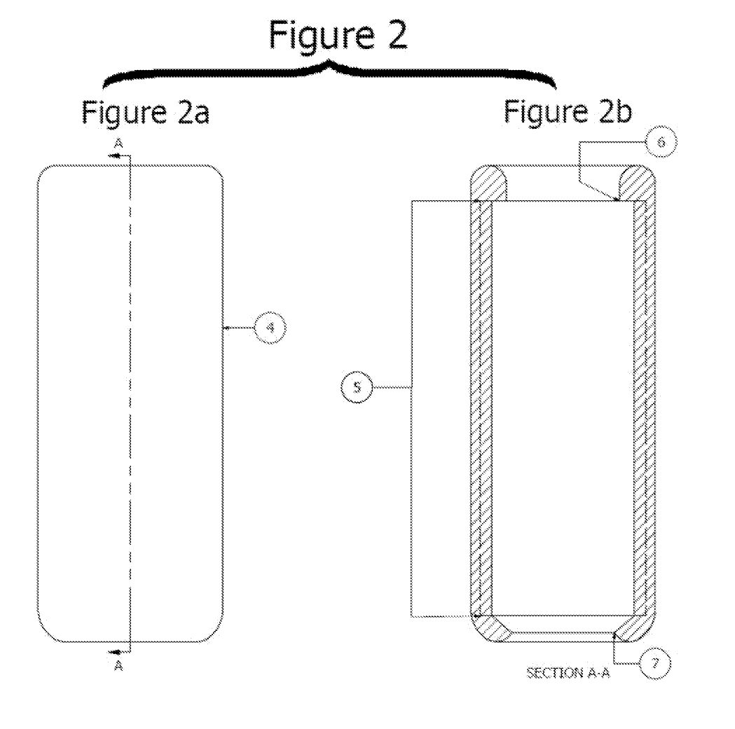

FIG. 2: The threaded barrel is shown with a sectioned view to better show the: (4) barrel outer surface, (5) threaded region, (6) upper stop, and (7) lower ring. The threaded barrel houses and interacts with the eraser platform with the threaded region of the barrel (5). The threaded barrel connects to the ferrule assembly using the lower ring (7) allowing for axial rotation, while restricting longitudinal movement. The upper stop (6) prevents the eraser platform from leaving the barrel.

FIG. 2a: Side view of the threaded barrel showing where the cross section for FIG. 2b is located along with the: (4) barrel outer surface, (5) threaded region, (6) upper stop, and (7) lower ring.

FIG. 2b: Cross sectional view of the threaded barrel better showing the: (5) threaded region, (6) upper stop, and (7) lower ring.

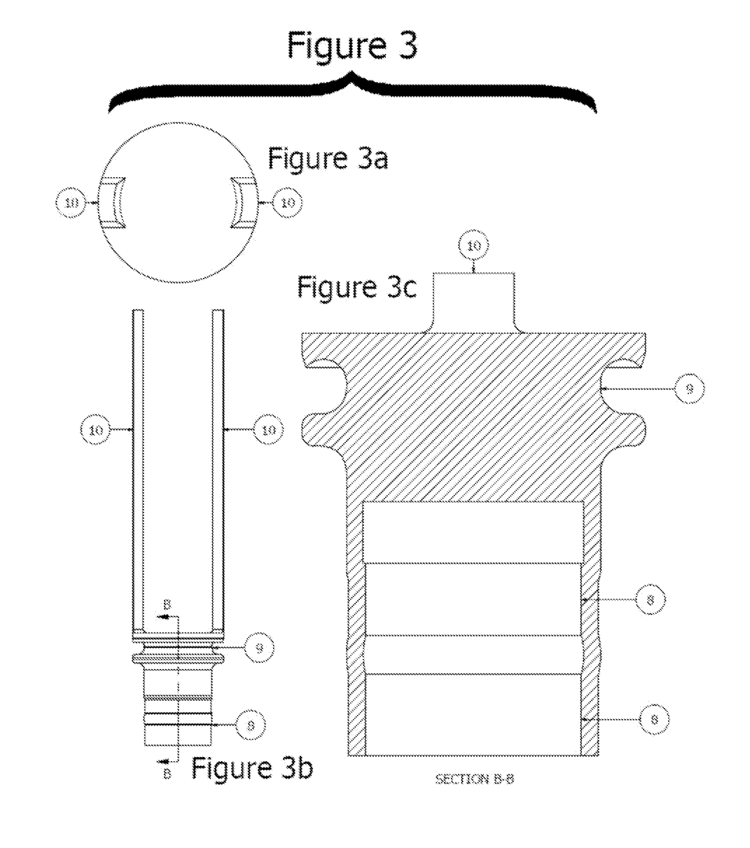

FIG. 3: The ferrule assembly is shown from several different positions with features shown: (8) compressed section, (9) circular raceway, and (10) Longitudinal guides. The ferrule assembly is rigidly attached to the pencil by means of compression (8). The ferrule assembly's circular raceway (9) longitudinally constrains the threaded barrel to the pencil while allowing for axial rotation of the barrel. The longitudinal guides (10) interact with the eraser platform preventing continuous rotation of the eraser platform.

FIG. 3a: Top view of the ferrule assembly showing the longitudinal guides (10).

FIG. 3b: Profile view of the ferrule assembly showing where the cross section for FIG. 3c is located along with the: (8) compressed section, (9) circular raceway, and (10) longitudinal guides.

FIG. 3c: Cross sectional view of the ferrule assembly better showing the compressed section (8) and the circular raceway (9).

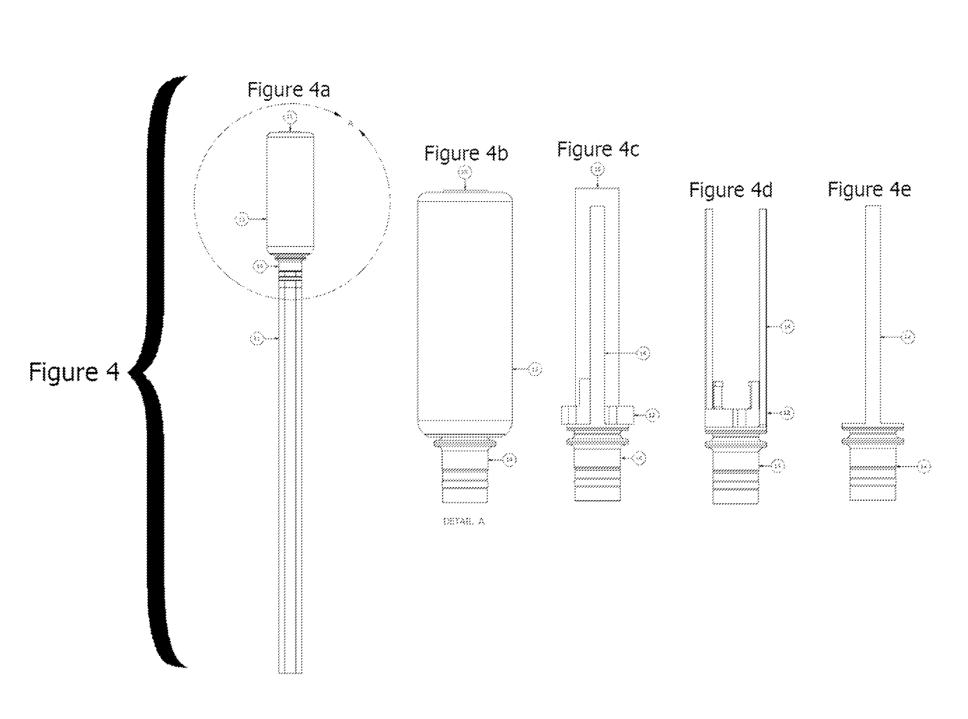

FIG. 4: The complete adjustable eraser assembly is shown on a wooden pencil demonstrating how the assembly is positioned. Features shown include the: (11) wooden pencil, (12) eraser platform, (13) threaded barrel, (14) ferrule assembly, and (15) eraser. The ferrule assembly (14) is rigidly connected to the wooden pencil. The threaded barrel (13) interacts with the ferrule assembly (14) in such a way as to allow rotational movement along the wooden pencil's (11) axis while restricting longitudinal movement. The eraser platform (12) is positioned inside the threaded barrel (13) with their respective threaded regions interlocked to allow for longitudinal movement. The ferrule assembly (14) includes several extrusions which prevent the eraser platform (12) from freely rotating, causing the eraser platform (12) to move longitudinally. The eraser (15) is rigidly attached to the eraser platform (12) allowing for the eraser's exposed length to be adjustable.

FIG. 4a: The complete adjustable eraser assembly is shown on a wooden pencil with the detail section shown which is used in FIG. 4b to FIG. 4e, also shown is the: (11) wooden pencil, (13) threaded barrel, (14) ferrule assembly, and (15) eraser.

FIG. 4b: The complete adjustable eraser assembly is shown without the wooden pencil, features shown include: (13) threaded barrel, (14) ferrule assembly, and (15) eraser.

FIG. 4c: The adjustable eraser assembly is shown without the threaded barrel to better show the: (12) eraser platform, (14) ferrule assembly, and (15) eraser.

FIG. 4d: The adjustable eraser assembly is shown without the threaded barrel and the eraser to show the eraser platform (12) and ferrule assembly (14).

FIG. 4e: The adjustable eraser assembly is shown without the threaded barrel, the eraser, and the eraser ferrule to show the ferrule assembly (14).

The invention claimed is:

1. A writing assembly comprising of:
a lead pencil, guide rails, a ferrule, a circular raceway, an eraser platform with threaded extrusions and a threaded barrel with an outer stop;

2. The writing assembly of claim 1, wherein said assembly can be a wooden pencil.

3. The writing assembly of claim 1, wherein said assembly can be a non wooden pencil.

4. The writing assembly of claim 1, wherein said assembly can be a mechanical pencil.

5. The writing assembly of claim 1, wherein said assembly allows for 3:1 lead to eraser ratio.

6. The writing assembly of claim 1, wherein said assembly has a threaded barrel and guide.

7. The writing assembly of claim 1, wherein said assembly has a threaded barrel and guide that is ergonomic.

8. The writing assembly of claim 1, wherein said assembly has an eraser that can be replaced.

9. The writing assembly of claim 1, wherein said assembly has an eraser that is exposed by turning the threaded barrel and guide assembly, which moves the eraser up.
